(19) United States
(12) Patent Application Publication
(10) Pub. No.: US 2003/0012026 A1
(43) Pub. Date: Jan. 16, 2003

(54) Track structure of track lighting

(76) Inventor: Wei Hong Shen, Hsinchuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/903,528

(22) Filed: Jul. 13, 2001

(51) Int. Cl. H01K 1/62

(52) U.S. Cl. 362/382; 362/418

(57) ABSTRACT

A track structure for track lighting mainly comprises a conductive track, an insulative strip and a conductive strip. The conductive track has an indent dent on a bottom side thereof, two opposite sidewalls and an accommodation space formed between the two sidewalls. The insulative strip is embedded in the insulative strip and the conductive strip is arranged below the insulative strip. Each of the sidewalls has a thread portion on an inner bottom end thereof whereby the track lighting is screwed to the thread portion for assembling. The track lighting has one electrode connected to the conductive track and another electrode connected to the conductive strip.

### FIELD OF THE INVENTION

The present invention relates to a track structure for track lighting, especially to a track structure for track lighting with simple structure and the track lighting being assembled to the track structure by screw.

### BACKGROUND OF THE INVENTION

The lighting provides versatile functions for house decoration. Various lightings such as table lighting, desktop lighting, ceiling lamp and track lighting are extensively used.

FIG. 1 shows a perspective view of a prior art track lighting 2a and the bar frame 1a thereof. The bar frame 1a has a clamping groove 10a on each lateral opening thereof and an insulative strip 11a in each clamping groove 10a. The insulative strip 11a has a clamping recess 12a therein and clamping a conductive strip 13a. The track lighting 2a further has a clamping arm 20a and two clamping plates 21a screwed on top portion of the clamping arm 20a. The two clamping plates 21a are clamped to the respective conductive strips 13a such that electric power is transmitted to the track lighting 2a through the conductive strips 13a.

However, the prior art track lighting 2a uses conductive strips 13a to convey electric power, the structure thereof is complicated. Moreover, the provision of a clamping arm 20a and two clamping plates 21a increases the weight of the track lighting 2a and occupies considerable space.

### SUMMARY OF THE INVENTION

It is the object of the present invention to provide a track structure for track lighting with simple structure and the track lighting being assembled to the track structure by screw.

To achieve above object, the present invention provides a track structure for track lighting mainly having a conductive track, an insulative strip and a conductive strip. The conductive track has an indent dent on a bottom side thereof, two opposite sidewalls and an accommodation space formed between the two sidewalls. The insulative strip is embedded in the insulative strip and the conductive strip is arranged below the insulative strip. Each of the sidewalls has a thread portion on an inner bottom end thereof whereby the track lighting is screwed to the thread portion for assembling. The track lighting has one electrode connected to the conductive track and another electrode connected to the conductive strip.

The various objects and advantages of the present invention will be more readily understood from the following detailed description when read in conjunction with the appended drawing, in which:

### BRIEF DESCRIPTION OF DRAWING

FIG. 1 shows a perspective view of a prior art track lighting;

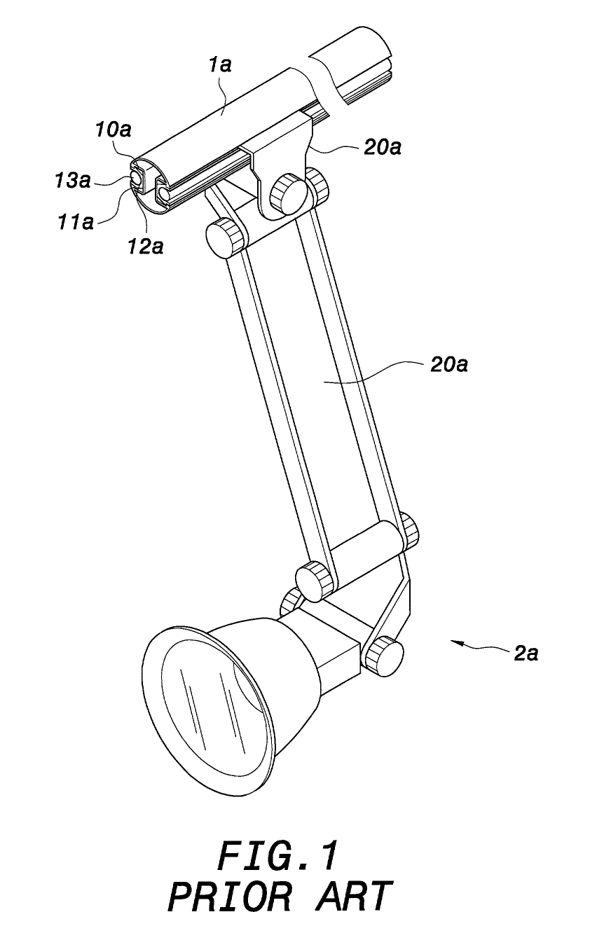

FIG. 2 shows an exploded view of the present invention;

FIG. 3 shows a perspective view of the present invention;

FIG. 4 shows a sectional view of the present invention;

FIG. 5 shows the application of the present invention; and

FIG. 6 shows a sectional view of another preferred embodiment of the present invention.

### DETAILED DESCRIPTION OF THE INVENTION

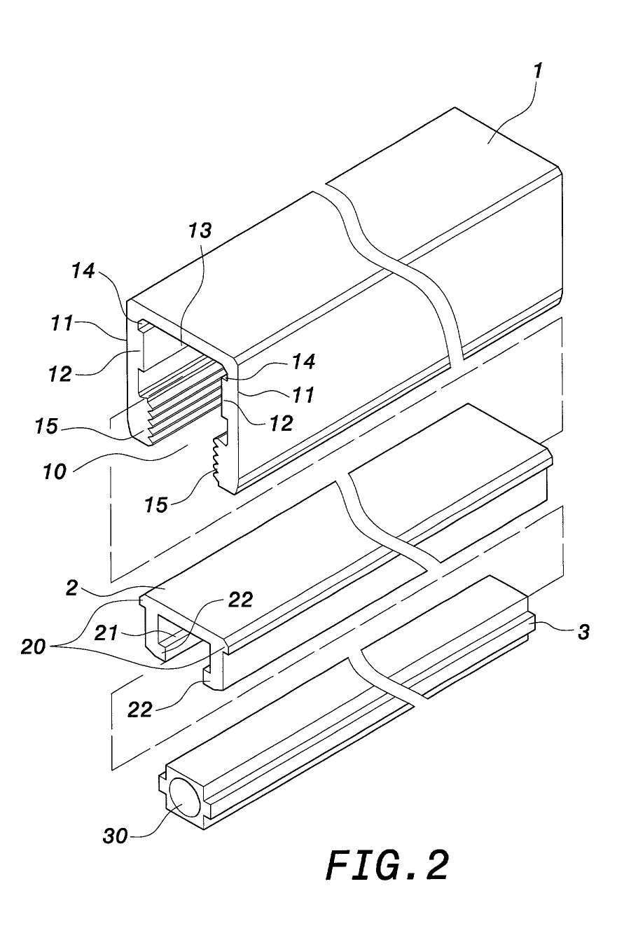

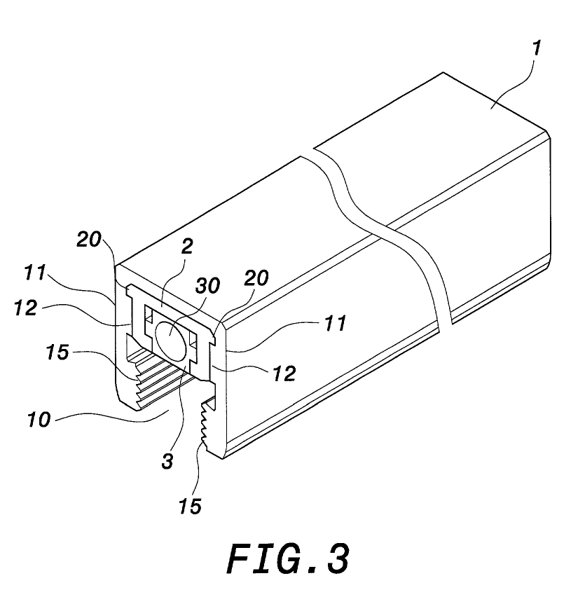

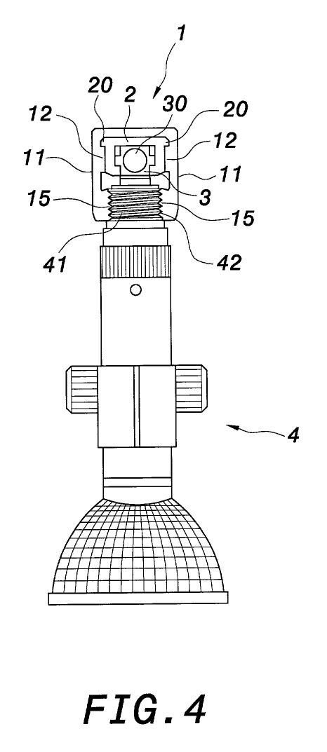

FIG. 2 shows an exploded view of the present invention and FIG. 3 shows a perspective view of the present invention, respectively. The inventive track structure for track lighting mainly comprises a conductive track 1, an insulative strip 2 and a conductive strip 3. The conductive track 1 is made of conductive material and has an indent dent 10 on bottom side thereof, and has two opposite sidewalls 11 such that the conductive track 1 has a U-shaped cross section. Each of the sidewalls 11 has a bump 12 on inner surface thereof. An accommodation space 13 is formed among the two bumps and the top portion of the dent 10. The accommodation space 13 has a clamping groove 14 on each of the two lateral sides thereof. Each of the sidewalls 11 has a thread portion 15 on inner bottom end thereof. The thread portion 15 has a pitch matched with a thread portion 42 of a cathode 41 of a track lighting 4 as shown in FIG. 4.

The insulative strip 2 is of elongated shape and arranged in the accommodation space 13 and has two lateral flanges 20 on two top lateral ends thereof. The two lateral flanges 20 are embedded into respective clamping grooves 14 to assemble the conductive track 1 with the insulative strip 2. Moreover, the insulative strip 2 has an indent groove 21 on lower side thereof and the indent groove 21 has two inward flanges 22 on two lateral sides thereof.

The conductive strip 3 is also made of conductive material and has a cruciform cross section, or has a cross sectional shape matched with that of the indent groove 21, whereby the conductive strip 3 is supported by the two inward flanges 22 of the indent groove 21 and the conductive strip 3 is embedded within the indent groove 21. Moreover, the conductive strip 3 has two coupling holes 30 on both distal ends thereof. The coupling hole 30 can be engaged with a track connector (not shown), thereby assembling a plurality of conductive tracks 1.

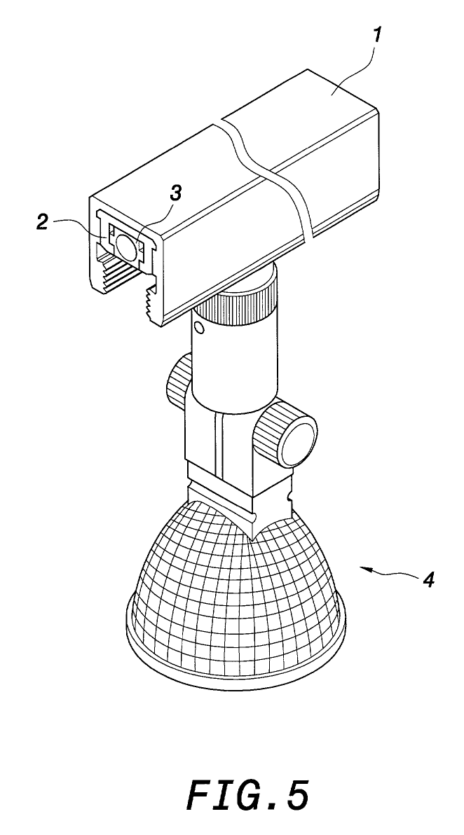

As shown in FIGS. 4 and 5, the track lighting 4 is a conventional one and has an anode 40 and a cathode 41. The cathode 41 has a thread portion 42 with pitch matched with the thread portion 15 of the conductive track 1 as shown in FIG. 4. Therefore, the conductive track 1 is electrically connected to the cathode 41 of the track lighting 4. The conductive strip 3 is electrically connected to the anode 40 of the track lighting 4. Therefore, the conductive track 1 and the conductive strip 3 can provide electric power to the track lighting 4, and the track lighting 4 can be screwed into the indent dent 10. The track lighting 4 can be assembled with a compact structure.

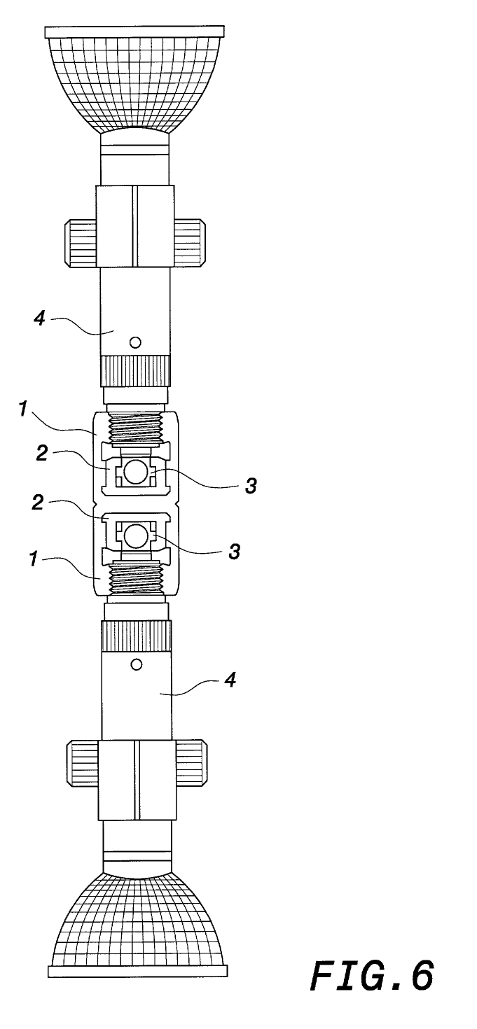

As shown in FIG. 6, another conductive track 1 is stacked atop the conductive track 1 with opposite orientation and also has an insulative strip 2 and a conductive strip 3 therein. The stacked conductive tracks 1 can be used to accommodate more track lighting 4.

Moreover, the track lighting 4 uses electric power of 12 volt, which is not dangerous to human body. Therefore, the inventive track structure for track lighting does not have hazardous problem.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

I claim

1. A track structure for track lighting mainly comprising
a conductive track made of conductive material and having indent dent on a bottom side thereof, two opposite sidewalls and an accommodation space formed between the two sidewalls, each of the sidewall having a thread portion on an inner bottom end thereof;
an insulative strip received in the accommodation space; and
a conductive strip also made of conductive material and arranged below the insulative strip;
the track lighting being screwed to the thread portion for assembling.

2. The track structure for track lighting as in claim 1, wherein another conductive track is stacked atop the conductive track with opposite orientation, and also has an insulative strip and a conductive strip therein.

3. The track structure for track lighting as in claim 1, wherein the conductive track has a U-shaped cross section.

4. The track structure for track lighting as in claim 1, wherein each of the sidewalls has a bump on inner surface thereof to form the accommodation space.

5. The track structure for track lighting as in claim 1, wherein the accommodation space has a clamping groove on each of two lateral sides thereof, the insulative strip has two lateral flanges on two top lateral ends thereof, the two lateral flanges are embedded into respective clamping grooves.

6. The track structure for track lighting as in claim 1, wherein the thread portion of the sidewall has a pitch matched with a thread portion of a cathode of the track lighting.

7. The track structure for track lighting as in claim 1, wherein the insulative strip has an indent groove on lower side thereof and the conductive strip is embedded in the indent groove.

8. The track structure for track lighting as in claim 7, wherein the indent groove has two inward flanges on two lateral sides thereof.

9. The track structure for track lighting as in claim 1, wherein the conductive strip has a cruciform cross section.

10. The track structure for track lighting as in claim 1, wherein the conductive strip has two coupling holes on both distal ends thereof.
